(19) United States
(12) Patent Application Publication
(10) Pub. No.: US 2010/0272115 A1
(43) Pub. Date: Oct. 28, 2010

(54) GATEWAY-BASED MANAGEMENT IN A COMMUNICATION NETWORK

(76) Inventor: Rajesh Ramankutty, Nashua, NH (US)

Correspondence Address: WILMERHALE/BOSTON, 60 STATE STREET, BOSTON, MA, 02109, US

(21) Appl. No.: 12/765,322

(22) Filed: Apr. 22, 2010

Related U.S. Application Data
(60) Provisional application No. 61/171,608, filed on Apr. 22, 2009.

(51) Int. Cl. H04L 12/66; G06F 15/173

(52) U.S. Cl. 370/401; 709/223

(57) ABSTRACT

Systems and methods for providing operations and management functions at a gateway in a communications network are disclosed. These management abilities allow the gateway to perform functions that improve resource distribution, allow for maintenance and upgrades, and provide session management and policy enforcement at the gateway. In some embodiments, a serving gateway (SGW) initiates a bearer or session change and subsequently sends a bearer request message to a mobility management entity (MME). In other embodiments, an SGW may exchange information with an MME, a second SGW or a serving GPRS support node (SGSN) using a private extension to an echo message. In other embodiments, an SGW may feature a command line interface that can be used to instruct the SGW to not accept new calls or sessions, or to take itself out of service.

### CROSS-REFERENCE TO RELATED APPLICATIONS

This application claims benefit under 35 U.S.C. §119(e) of U.S. Provisional Patent Application No. 61/171,608, entitled “Gateway-Based Management in a Communication Network,” filed Apr. 22, 2009, which is hereby incorporated by reference herein in its entirety.

### FIELD OF THE DISCLOSURE

This invention relates to the field of telecommunications, and more particularly, a system and method for providing management at a gateway in a communication network.

### BACKGROUND

Wireless networks are telecommunications networks that use radio waves to carry information from one node in the network to one or more receiving nodes in the network. Wired communication can also be used in portions of a wireless network, such as between cells or access points. Cellular telephony is characterized by the use of radio cells that provide radio coverage for a geographic area, with multiple cells arranged to provide contiguous radio coverage over a larger area.

The first generation of wireless telephone technology used analog mobile phones in which analog information signals were transmitted. As technology progressed a second generation (2G) of wireless service was introduced. In 2G systems, digital information signals were used to modulate a carrier. These 2G technologies used time division multiplexed access (TDMA) or code division multiple access (CDMA) technologies to distinguish multiple users. Networks that were upgraded to handle higher-speed packet data in networks were referred to as 2.5G and 3G networks. The 3rd Generation Partnership Project (3GPP) and the 3rd Generation Partnership Project 2 (3GPP2), respectively, developed the GSM/UMTS/HSDPA and cdmaOne/CDMA2000 technologies. The next evolution is 4G technology, which is referred to as long term evolution-system architecture evolution (LTE-SAE) and uses orthogonal frequency division multiple access (OFDMA) technology.

Other wireless protocols have also developed, including WiFi, an implementation of various IEEE 802.11 protocols, WiMAX, an implementation of IEEE 802.16, and HiperMAN, which is based on an ETSI alternative to IEEE 802.16.

Wireless communication technologies are used in connection with many applications, including, for example, satellite communications systems, portable digital assistants (PDAs), laptop computers, and mobile devices (e.g., cellular telephones, user equipment). One benefit that users of such applications can obtain is the ability to connect to a network (e.g., the Internet) as long as the user is within range of such a wireless communication technology.

### SUMMARY OF THE INVENTION

Systems and methods for providing management at a gateway in a communications network are disclosed. These management abilities allow the gateway to perform functions that improve resource distribution, allow for maintenance and upgrades, and provide session management and policy enforcement at the gateway. In some embodiments, features are provided that are not provided in a standards-based serving gateway (SGW).

In some embodiments, a method is disclosed that includes supporting a session on at least one serving gateway (SGW) with a User Equipment (UE), where the SGW is configured to route and forward user data packets, which allows the UE to send and receive data with other network devices, initiating at least one of a bearer and session change at the SGW by operations and management functions of the SGW, sending a bearer request message from the SGW to a mobility management entity (MME), and receiving a bearer response message from the MME at the SGW and completing the at least one of a bearer and session change at the SGW in accordance with the change initiated at the SGW.

In other embodiments, an apparatus is disclosed that includes a communication means for sending and receiving data packets to and from at least one network device on a packet-based network and for sending bearer request messages to a mobility management entity (MME), a gateway means for routing and forwarding user data packets and supporting at least one session with a User Equipment (UE), which allows the UE to send and receive content with other network devices, and a means for providing operations and management functions including initiating at least one of a bearer and session change at the gateway means, wherein the gateway means communicates with at least one of the MME and a serving GPRS support node (SGSN) to continue executing at least one of a bearer and session change initiated at the gateway means.

In yet other embodiments, a serving gateway (SGW) is disclosed that includes an interface, configured to send and receive data packets to and from at least one network device on a packet-based network to support at least one session on the SGW with a User Equipment (UE), and configured to send bearer request messages from the SGW to a mobility management entity (MME), and a processing unit, in communication with a storage medium to provide operations and management functions on the serving gateway including initiating at least one of a bearer and session change at the SGW, wherein the SGW communicates with at least one of the MME and a serving GPRS support node (SGSN) to continue executing at least one of a bearer and session change initiated at the SGW.

### BRIEF DESCRIPTION OF THE DRAWINGS

FIG. 1 illustrates a network diagram in accordance with certain embodiments;

FIG. 2 illustrates a gateway initiated bearer disconnect in accordance with certain embodiments;

FIG. 3 illustrates a gateway initiated session disconnect in accordance with certain embodiments;

FIG. 4 illustrates a gateway initiated session relocation disconnect in accordance with certain embodiments;

FIG. 5 illustrates gateway reporting of information in accordance with certain embodiments;

FIG. 6 illustrates gateway selection at a MME using a selection logic in accordance with certain embodiments; and

FIG. 7 illustrates a chassis in accordance with certain embodiments.

### DETAILED DESCRIPTION

Systems and methods are disclosed that provide management at a gateway in a communication network. In a communication network, some network devices provide operations and management (O&M) functions and system management functions that are used in providing services to a user of the network. These functions allow the network device to disconnect, relocate, and report information to other devices, for example, which can increase the efficiency of the network. The provision of O&M functions and system management functions at a network device can also support other functions on the network such as better distribution of services, avoiding overloaded gateways, and others. The gateway can be a gateway GPRS support node (GGSN), a serving GPRS support node (SGSN), a mobility management entity (MME), a serving gateway (SGW), or a packet data network gateway (PGW), for example. The gateway can also be implemented on a Starent Networks, Corp. chassis platform that is further described below.

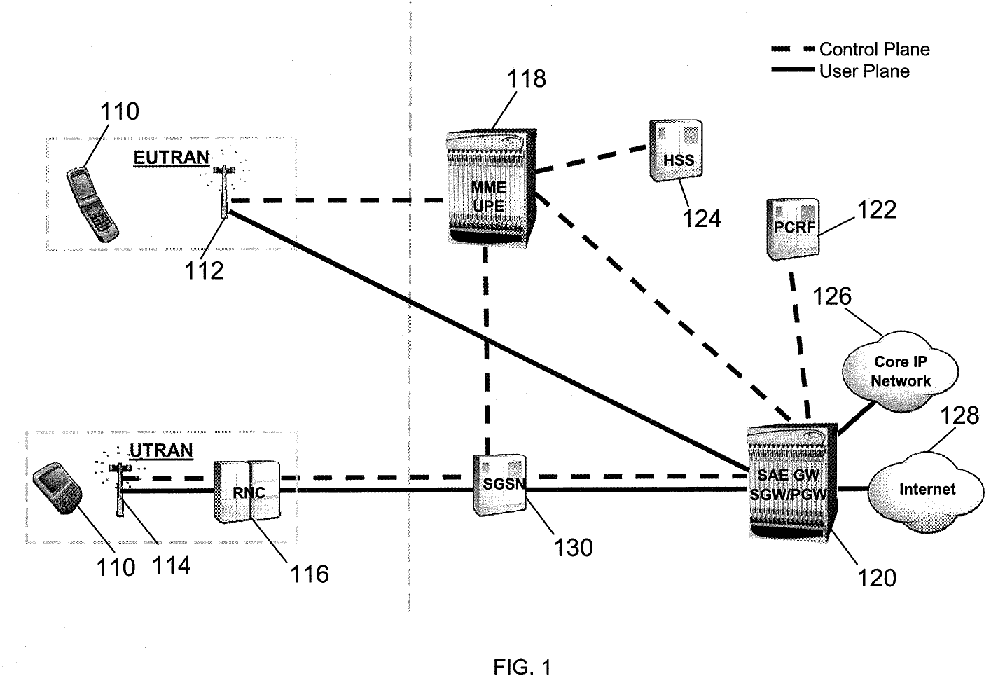

FIG. 1 illustrates an implementation in a long term evolution (LTE) network in accordance with certain embodiments. FIG. 1 illustrates both a universal mobile telecommunication system (UMTS) release 8 network and a LTE network. The network diagram of FIG. 1 includes user equipment (UE) 110, an evolved nodeB (eNB) 112, a nodeB 114, a radio network controller (RNC) 116, a mobility management entity (MME)/user plane entity (UPE) 118, a system architecture evolution gateway (SAE GW) 120, a policy and charging rules function (PCRF) 122, home subscriber server (HSS) 124, core IP network 126, internet 128, and Serving General packet radio service Support Node (SGSN) 130. The MME 118, SAE GW 120, and SGSN 130 can be implemented in a chassis as described below. The SAE GW 120 can include a serving gateway (SGW) as well as a packet data network gateway (P-GW). In some embodiments, the SGW and P-GW can be implemented on separate network devices. The main component of the SAE architecture is the Evolved Packet Core (EPC), also known as SAE Core. The EPC includes the MME, SGW and P-GW components.

MME 118 is a control-node for the LTE access network. The MME 118 is responsible for UE 110 tracking and paging procedures including retransmissions. MME 118 handles the bearer activation/deactivation process and is also responsible for choosing the SGW for a UE 110 at the initial attach and at time of an intra-LTE handover. The MME 118 also authenticates the user by interacting with the HSS 124. The MME 118 also generates and allocates temporary identities to UEs and terminates Non-Access Stratum (NAS) signaling. The MME 118 checks the authorization of the UE 110 to camp on the service provider's Public Land Mobile Network (PLMN) and enforces UE roaming restrictions. The MME 118 is the termination point in the network for ciphering/integrity protection for NAS signaling and handles the security key management. Lawful interception of signaling is also supported by the MME 118. The MME also provides the control plane function for mobility between LTE and 2G/3G access networks with the S3 interface terminating at the MME 118 from the SGSN 130. The MME 118 also terminates the S6a interface towards the home HSS for roaming UEs.

The SGW routes and forwards user data packets, while also acting as the mobility anchor for the user plane during inter-eNB handovers and as the anchor for mobility between LTE and other 3GPP technologies (terminating S4 interface and relaying the traffic between 2G/3G systems and PDN GW). For idle state UEs, the SGW terminates the down link data path and triggers paging when down link data arrives for the UE 110. The SGW manages and stores UE contexts, e.g. parameters of the IP bearer service and network internal routing information. The SGW also performs replication of the user traffic in case of lawful interception. The P-GW provides connectivity to the UE 110 to external packet data networks by being the point of exit and entry of traffic for the UE 110. A UE 110 may have simultaneous connectivity with more than one P-GW for accessing multiple packet data networks. The P-GW performs policy enforcement, packet filtering for each user, charging support, lawful interception, and packet screening. The P-GW also provides an anchor for mobility between 3GPP and non-3GPP technologies such as WiMAX and 3GPP2 (CDMA 1X and EvDO). The SGW or the PGW, depending on the embodiment, can be used to provide deep packet inspection and provide advertising to the user on a per subscriber basis as described above on a chassis implementing a SGW or a PGW.

The gateway modified for supporting operation and management functions can initiate bearer changes and session changes. In some embodiments, a request message is used to initiate bearer or session changes from a device other than a management server, such as a mobility management entity (MME) or a serving GPRS support node (SGSN). In order to initiate the bearer or session change from a device other than the management server, a variety of messages can be used or fields can be added to an existing message. The variety of messages can include proprietary and other existing messages. The message or field in the existing message specifies to the management server the action to take, such as changing a bearer. In embodiments where an existing message is used, the field can be appended to the message, an existing field can be used to indicate the action type, or an extension such as a vendor specific extension (VSE) can be used. Vendor-specific extensions (VSEs) are a way to add proprietary messaging to a message that is standardized for interoperability with other devices. In some embodiments, multiple fields are added to the message to provide information as well as initiate a particular action.

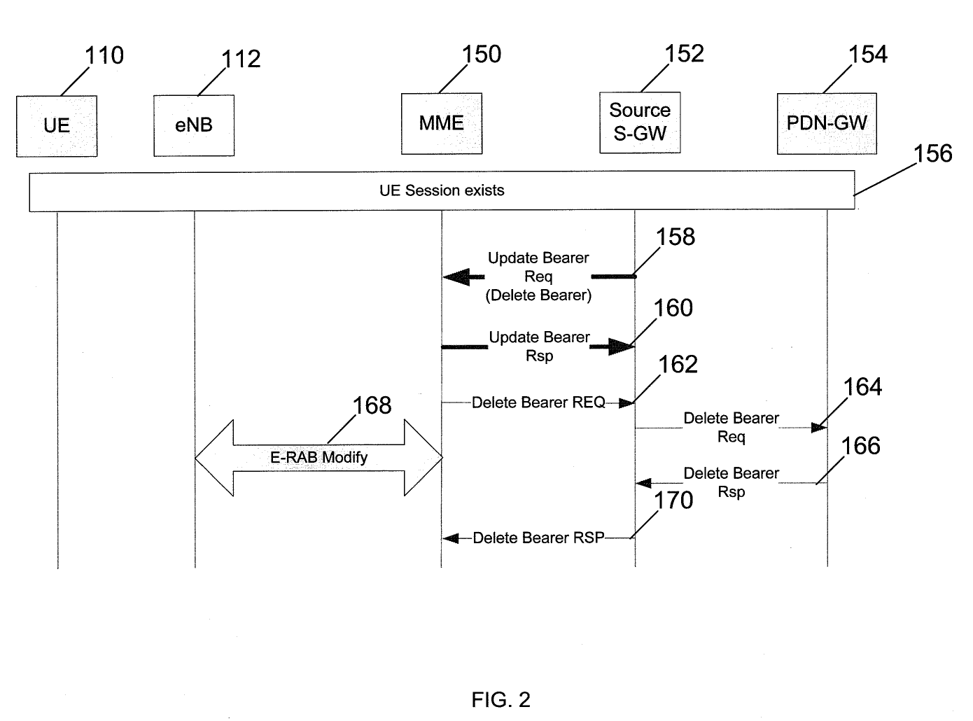

FIG. 2 illustrates a gateway initiated bearer disconnect in accordance with certain embodiments. FIG. 2 includes user equipment (UE) 110, evolved node B (eNB) 112, a mobility management entity (MME) 150, a serving gateway (SGW) 152, and a packet data network gateway (PGW) 154. In 156, a session already exists for UE 110 in the communication network. The session allows UE 110 to, for example, send and receive VoIP calls, emails, and send and receive content over the Internet. SGW 152 can send a bearer request message to delete, disconnect, add, or modify a bearer handled by the SGW 152. The bearer request message uses a field in the message to specify the action to take. The field, for example, can be appended to the request message, can be another field can be used to indicate the action type, or can be an extension such as a vendor specific extension (VSE). A proprietary message can also be used by the SGW to initiate operations and management functions. The SGW 152 sends an update bearer request message 158 to MME 150 to delete a bearer being supported by the SGW 152. After processing the update bearer message 158, MME 150 sends an update bearer response message 160 to SGW 152. MME 150 sends a delete bearer request message 162 to SGW 152 to delete the bearer. SGW 152 sends a delete bearer request message 164 to PGW 154 to delete the bearer from PGW 154. PGW 154 can then delete the bearer. PGW 154 sends SGW 152 a delete bearer response message 166. In 168, the evolved-radio access bearer (E-RAB) is modified in accordance with the bearer change initiated by SGW 152. SGW 152 sends MME 150 a delete bearer response message 170 in response to the delete bearer request message 162.

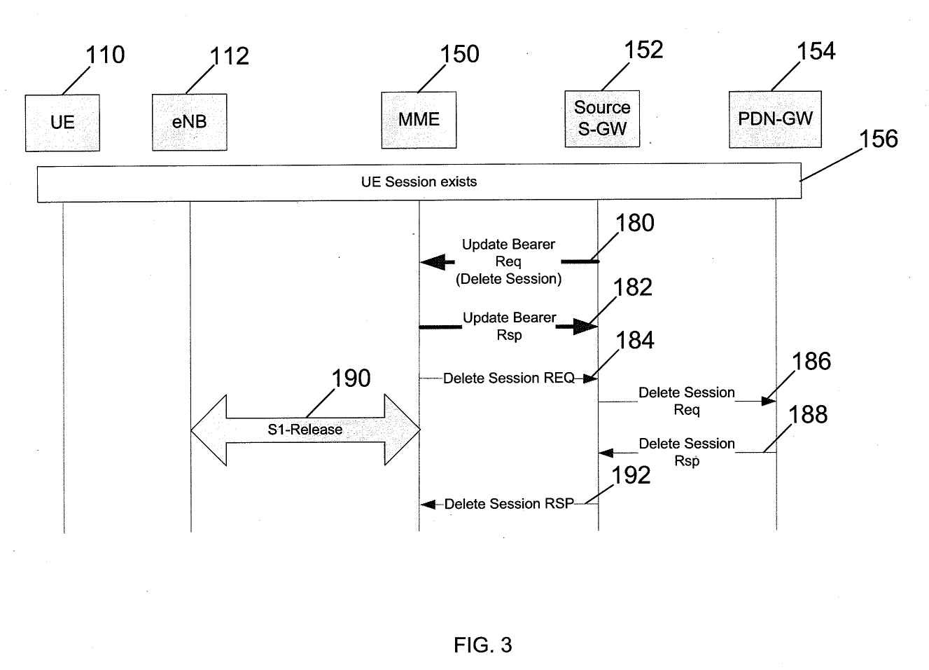

FIG. 3 illustrates a gateway initiated session disconnect in accordance with certain embodiments. FIG. 3 includes user equipment (UE) 110, evolved node B (eNB) 112, a mobility management entity (MME) 150, a serving gateway (SGW) 152, and a packet data network gateway (PGW) 154. In 156, a session already exists for UE 110 in the communication network. SGW 152 can send a bearer request message to delete, disconnect, add, or modify a session handled by the SGW 152. The SGW 152 sends an update bearer request message 180 to MME 150 to delete a session supported by the SGW 152. The delete session indication can be provided in a proprietary message, other than an update bearer request message, or can be indicated in an existing message. If an existing message is used, the field can be appended to the message, an existing field can be used to indicate the action type, or an extension such as a vendor specific extension (VSE) can be used. After processing the update bearer message 180, MME 150 sends an update bearer response message 182 to SGW 152. MME 150 sends a delete session request message 184 to SGW 152 to delete the session. SGW 152 sends a delete session request message 186 to PGW 154 to delete the session from PGW 154. PGW 154 can then delete the session. PGW 154 sends SGW 152 a delete session response message 188. In 190, a S1-release occurs in accordance with the session change initiated by SGW 152. SGW 152 sends MME 150 a delete session response message 192 in response to the delete session request message 184.

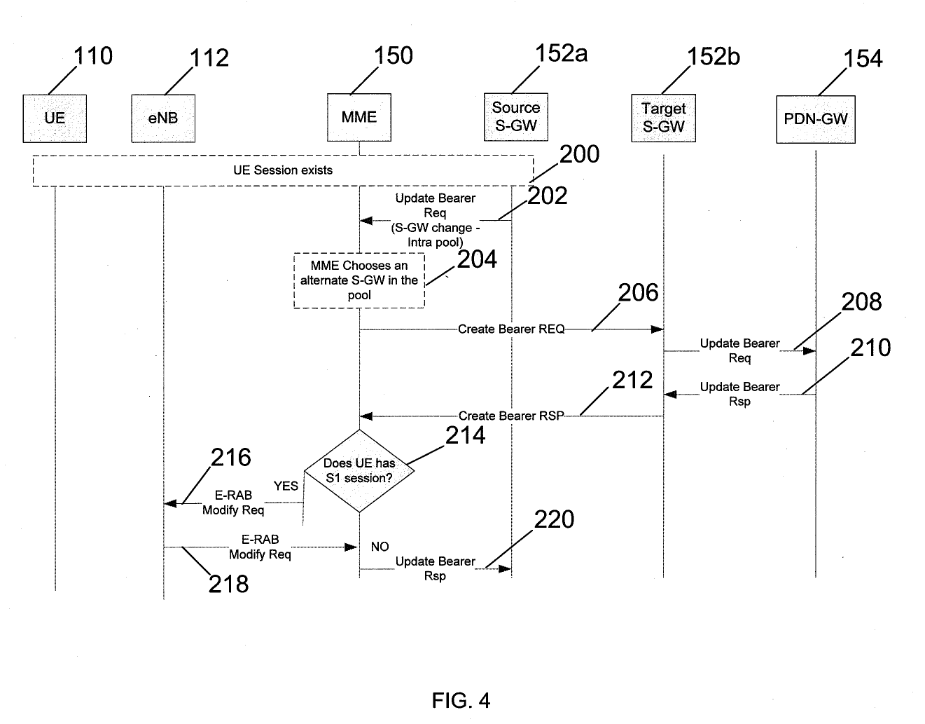

FIG. 4 illustrates a gateway initiated session relocation in accordance with some embodiments. FIG. 4 includes user equipment (UE) 110, evolved node B (eNB) 112, a mobility management entity (MME) 150, a source serving gateway (SGW) 152A, a target SGW 152B, and a packet data network gateway (PGW) 154. In 156, a session already exists for UE 110 in the communication network. In 200, a session already exists for UE 110 in the communication network which is being supported on SGW 152A. In initiating a session relocation, SGW 152A sends an update bearer request message 202 to MME 150. The update bearer request message 202 can indicate an SGW session change, for example, an intra pool session change. The session change indication can be provided in a proprietary message other than an update bearer request message or can be indicated in an existing message in another field or as an extension such as a vendor specific extension (VSE). In 204, MME 150 chooses an alternate SGW in the SGW pool. MME 150 sends a create bearer request 206 to target SGW 152B to create a session. Target 152B sends an update bearer request 208 to PGW 154 to modify information regarding the SGW handling the session. PGW 154 sends a update bearer response 210 to the target SGW 152B, which can indicate the changes made at PGW 154. Target SGW 152B sends a create bearer response 212 to MME 150, which can indicate the session setup that has occurred. In 214, MME 150 determines if the UE has a S1 session. If the UE does, a evolved-radio access bearer (E-RAB) message is sent to eNB 112 to modify the E-RAB to accommodate the session relocation. The eNB 112 responds with a E-RAB modify response message 218, which can indicate the modifications have been made. If the UE does not have a S1 session, then the MME 150 sends a update bearer response message 220 to SGW 154A.

The relocation mechanism described in FIG. 4 can be extended to support inter-SGW pool relocation. This can be used if SGW pools overlap and there is sufficient capacity in the other SGW pool to accommodate the UE connections being relocated. An intra-SGW pool relocation can occur when a MME supports both of the SGWs in a SGW pool. An inter-SGW pool relocation can occur when a request is sent to another MME with a different SGW pool.

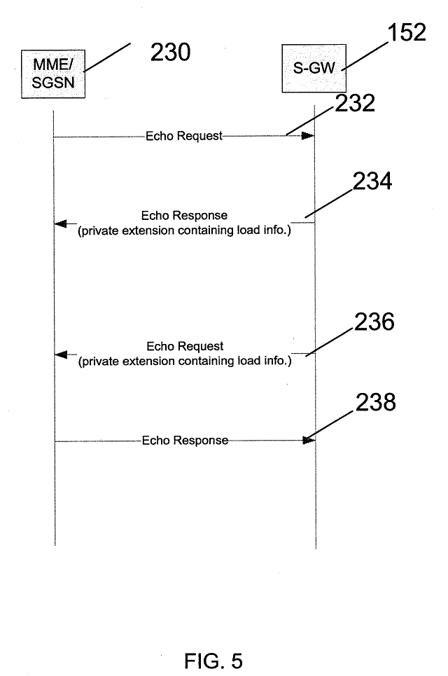

FIG. 5 illustrates gateway reporting of information in accordance with certain embodiments. The gateway can report information, such as load information, gateway health, error logs, billing information, policy information, or any other applicable information. FIG. 5 includes a MME/SGSN 230 and a SGW 152. The MME/SGSN 230 sends an echo request 232 to SGW 152. In response to the echo request, the SGW 152 sends a echo response message 234 which can include a private extension that is used to carry information, such as load information. The SGW 154 can also request information from the network, for example, by sending an echo request message 236. The echo request messaging can include a private extension that requests particular information. The MME/SGSN 230 responds with an echo response 238 that includes the information requested.

The information exchanged with a gateway can be used for gateway selection, implementing redundancy operations, and for maintaining quality of service (QoS). For example, in implementing redundancy operations, a first SGW can send a second SGW information about the sessions that the first SGW is handling, so that the second SGW can resume operations of the first SGW in the event of a failure or other situation.

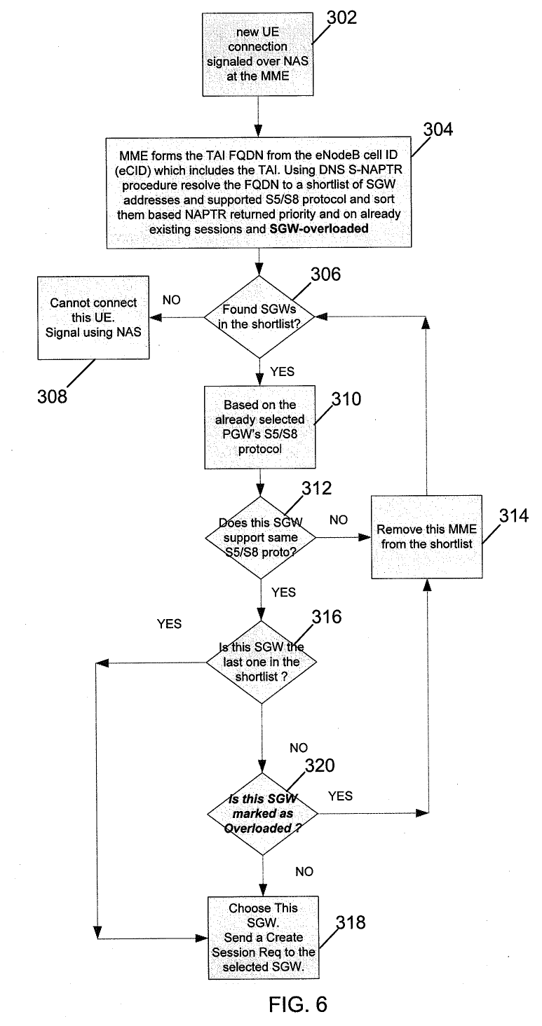

FIG. 6 illustrates gateway selection at a MME using a selection logic in accordance with some embodiments. The selection logic can be stored in a computer readable medium that is accessible by a processor on a chassis implementing the MME. In 302, a new UE connection is signaled over the non access stratum (NAS) protocol to the MME. In 304, the MME forms a tracking area identity fully qualified domain name (TAI FQDN) from the eNodeB cell ID (eCID) including the tracking area identity. Using DNS straightforward-name authority pointer (S-NAPTR) procedure, the MME resolves the FDQN to a shortlist of SGW addresses and supported S5/S8 protocols. These are sorted based on a combination of NAPTR returned priority, on already existing sessions, and overload weighting. The overload weighting can be SGW or PGW loading conditions as represented in the data structure.

In 306, the MME finds SGWs in the shortlist created in 304. If no SGWs are found in the shortlist in 306, this UE cannot connect using NAS and the MME signals the UE that a session cannot be established in 408. If a SGW can be found in 306, a PGW is selected in 310 based on the S5/S8 protocol. In 312, the MME checks whether the SGW supports the same S5/S8 protocol as the PGW. If not in 314, the SGW is removed from the MME shortlist and the process starts over with a modified shortlist in 306. If the SGW does support the same protocol in 312, then the MME checks if the SGW is the last one in the shortlist in 316. If the SGW is the last one in the shortlist in 316, this SGW is chosen in 318 and a create session request is sent to the selected SGW.

If the SGW is not the last one in the shortlist 316, then the MME checks whether the SGW is marked as overloaded in 320. If the SGW is marked as overloaded in 320, this entry can be checked for when the SGW was marked and the number of times the SGW has been selected from the shortlist. If the time meets a threshold or a threshold number of tries have been passed up, this SGW is chosen and the new result is written into the data structure. For example, if the attempt is successful then the SGW is unmarked. If the attempt is unsuccessful, then the entry is rewritten as being unsuccessful, resetting the time and number of attempts. If the threshold is not met in 420 and the SGW is marked as overloaded, then this is removed from the shortlist in 414. The PGW can go through the same overloaded check in the selection logic to determine the PGW selected.

The gateway can also be modified to allow for a command line interface to the software of the gateway. A command line interface provides an interface to send commands and instructions to a gateway. One command that can be sent to the gateway is a busy-out command. This command instructs the gateway to continue servicing existing calls or sessions until termination, but not to accept any new calls or sessions. These calls or sessions are denied via an error message such as resource-unavailable. Later, when the existing calls or sessions are disconnected, the gateway can be taken out of service. The command line interface can also be used to relocate sessions and disconnect or delete bearers or sessions based on identifying information such as access point name (APN), etc. The command line interface can also be used to initiate a switchover or other commands.

In some embodiments policy enforcement can be implemented on a gateway such as the SGW. This can include implementing a PCEF (Policy and Charging Enforcement Function). This is the functional element that encompasses policy enforcement and flow based charging functionalities. A PCEF's functionalities can include one or more of the following: control over the user plane traffic handling at the Gateway and its QoS, service data flow detection and counting and online and offline charging interactions. For a service data flow that is under policy control, the PCEF allows the service data flow to pass through the Gateway if and only if the corresponding gate is open. For a service data flow that is under charging control, the PCEF allows the service data flow to pass through the Gateway if and only if there is a corresponding active policy and charging control (PCC) rule and, for online charging, the online charging system (OCS) has authorized the applicable credit with that Charging key. If requested by the policy and charging rules function (PCRF), the PCEF can report to the PCRF when the status of the related service data flow changes. In case the service data flow (SDF) is tunnelled at the bearer binding and event reporting function (BBERF), the PCEF can inform the PCRF about the mobility protocol tunneling header of the service data flows at Internet protocol connectivity access network (IP-CAN) session establishment.

The functions on the gateway can be implemented by modifying the software of a chassis to support the functions. For example, the Linux based operating system running on the chassis supports a command line interface and the software running on the chassis can be modified to allow for decommissioning the gateway. Further, the software can be modified to change resources and send out message to change resources on other network devices.

The gateway described above can be implemented on a chassis with multiple and different integrated functionalities. In some embodiments, a mobility management entity (MME), a serving gateway (SGW), a PDN gateway (P-GW), an access gateway, a packet data serving node (PDSN), a foreign agent (FA), or home agent (HA) can be implemented on a chassis. Other types of functionalities that can also be implemented on a chassis in other embodiments are a Gateway General packet radio service Serving Node (GGSN), a serving GPRS support node (SGSN), a packet data inter-working function (PDIF), an access service network gateway (ASNGW), a base station, an access network, a User Plane Entity (UPE), an IP Gateway, an access gateway, a session initiation protocol (SIP) server, a proxy-call session control function (P-CSCF), and an interrogating-call session control function (I-CSCF), a serving gateway (SGW), and a packet data network gateway (PDN GW). In certain embodiments, one or more of the above-mentioned other types of functionalities are integrated together or provided by the same functionality. For example, an access network can be integrated with a PDSN. A chassis can include a PDSN, an FA, an HA, a GGSN, a PDIF, an ASNGW, a UPE, an IP Gateway, an access gateway, or any other applicable access interface device. In certain embodiments, a chassis is provided by Starent Networks, Corp. of Tewksbury, Mass. in a ST16 or a ST40 multimedia platform.

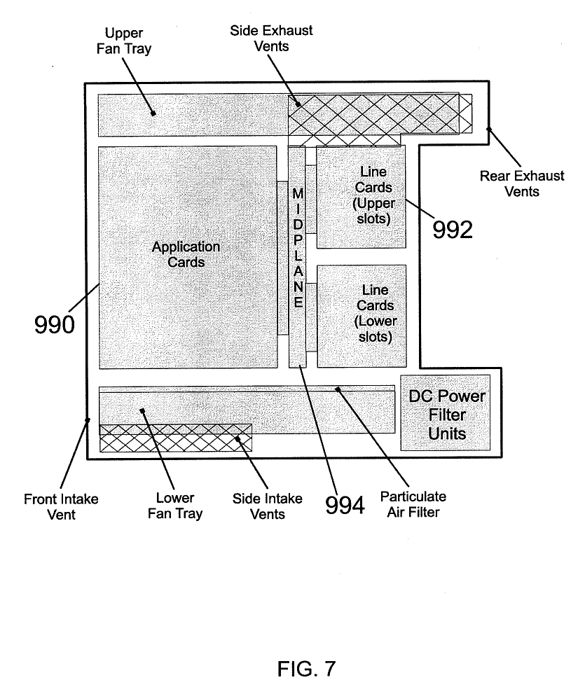

The features of a chassis that implements a gateway, in accordance with some embodiments, are further described below. FIG. 7 illustrates positioning of cards in the chassis in accordance with some embodiments. The chassis includes slots for loading application cards 990 and line cards 992. A midplane 994 can be used in the chassis to provide intra-chassis communications, power connections, and transport paths between the various installed cards. The midplane 994 can include buses such as a switch fabric, a control bus, a system management bus, a redundancy bus, and a time division multiplex (TDM) bus. The switch fabric is an IP-based transport path for user data throughout the chassis implemented by establishing inter-card communications between application cards and line cards. The control bus interconnects the control and management processors within the chassis. The chassis management bus provides management of system functions such as supplying power, monitoring temperatures, board status, data path errors, card resets, and other failover features. The redundancy bus provides transportation of user data and redundancy links in the event of hardware failures. The TDM bus provides support for voice services on the system.

The chassis supports at least four types of application cards: a switch processor card, a system management card, a packet service card, and a packet accelerator card. The switch processor card serves as a controller of the chassis and is responsible for such things as initializing the chassis and loading software configurations onto other cards in the chassis. The packet accelerator card provides packet processing and forwarding capabilities. Each packet accelerator card is capable of supporting multiple contexts. Hardware engines can be deployed with the card to support parallel distributed processing for compression, classification traffic scheduling, forwarding, packet filtering, and statistics compilations. The system management card is a system control and management card for managing and controlling other cards in the gateway device. The packet services card is a high-speed processing card that provides multi-threaded point-to-point, packet data processing, and context processing capabilities, among other things.

The packet accelerator card performs packet-processing operations through the use of control processors and a network processing unit. The network processing unit determines packet processing requirements; receives and transmits user data frames to/from various physical interfaces; makes IP forwarding decisions; implements packet filtering, flow insertion, deletion, and modification; performs traffic management and traffic engineering; modifies/adds/strips packet headers; and manages line card ports and internal packet transportation. The control processors, also located on the packet accelerator card, provide packet-based user service processing. The line cards when loaded in the chassis provide input/output connectivity and can also provide redundancy connections as well.

The operating system software can be based on a Linux software kernel and run specific applications in the chassis such as monitoring tasks and providing protocol stacks. The software allows chassis resources to be allocated separately for control and data paths. For example, certain packet accelerator cards can be dedicated to performing routing or security control functions, while other packet accelerator cards are dedicated to processing user session traffic. As network requirements change, hardware resources can be dynamically deployed to meet the requirements in some embodiments. The system can be virtualized to support multiple logical instances of services, such as technology functions (e.g., a PDN GW, SGW, PDSN, ASNGW, PDIF, HA, GGSN, or IPSG).

The chassis' software can be divided into a series of tasks that perform specific functions. These tasks communicate with each other as needed to share control and data information throughout the chassis. A task is a software process that performs a specific function related to system control or session processing. Three types of tasks operate within the chassis in some embodiments: critical tasks, controller tasks, and manager tasks. The critical tasks control functions that relate to the chassis' ability to process calls such as chassis initialization, error detection, and recovery tasks. The controller tasks mask the distributed nature of the software from the user and perform tasks such as monitor the state of subordinate manager(s), provide for intra-manager communication within the same subsystem, and enable inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is an aggregation of multiple other tasks. A single subsystem can include critical tasks, controller tasks, and manager tasks. Some of the subsystems that can run on a chassis include a system initiation task subsystem, a high availability task subsystem, a recovery control task subsystem, a shared configuration task subsystem, a resource management subsystem, a virtual private network subsystem, a network processing unit subsystem, a card/slot/port subsystem, and a session subsystem.

The system initiation task subsystem is responsible for starting a set of initial tasks at system startup and providing individual tasks as needed. The high availability task subsystem works in conjunction with the recovery control task subsystem to maintain the operational state of the chassis by monitoring the various software and hardware components of the chassis. The recovery control task subsystem is responsible for executing a recovery action for failures that occur in the chassis and receives recovery actions from the high availability task subsystem. The shared configuration task subsystem provides the chassis with an ability to set, retrieve, and receive notification of chassis configuration parameter changes and is responsible for storing configuration data for the applications running within the chassis. The resource management subsystem is responsible for assigning resources (e.g., processor and memory capabilities) to tasks and for monitoring the task's use of the resources.

The virtual private network (VPN) subsystem manages the administrative and operational aspects of VPN-related entities in the chassis, which include creating separate VPN contexts, starting IP services within a VPN context, managing IP pools and subscriber IP addresses, and distributing IP flow information within a VPN context. In some embodiments, within the chassis, IP operations are done within specific VPN contexts. The network processing unit subsystem is responsible for many of the functions listed above for the network processing unit. The card/slot/port subsystem is responsible for coordinating the events that occur relating to card activity, such as discovery and configuration of ports on newly inserted cards and determining how line cards map to application cards. The session subsystem is responsible for processing and monitoring a mobile subscriber's data flows in some embodiments. Session processing tasks for mobile data communications include: A10/A11 termination for CDMA networks, GSM tunneling protocol termination for GPRS and/or UMTS networks, asynchronous PPP processing, packet filtering, packet scheduling, Difsery codepoint marking, statistics gathering, IP forwarding, and AAA services, for example. Responsibility for each of these items can be distributed across subordinate tasks (called managers) to provide for more efficient processing and greater redundancy. A separate session controller task serves as an integrated control node to regulate and monitor the managers and to communicate with the other active subsystem. The session subsystem also manages specialized user data processing such as payload transformation, filtering, statistics collection, policing, and scheduling.

In some embodiments, the software needed for implementing a process or a database includes a high level procedural or an object-orientated language such as C, C++, C#, Java, or Perl. The software may also be implemented in assembly language if desired. Packet processing implemented in a chassis can include any processing determined by the context. For example, packet processing may involve high-level data link control (HDLC) framing, header compression, and/or encryption. In certain embodiments, the software is stored on a storage medium or device such as read-only memory (ROM), programmable-read-only memory (PROM), electrically erasable programmable-read-only memory (EEPROM), flash memory, or a magnetic disk that is readable by a general or special purpose-processing unit to perform the processes described in this document.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow.

What is claimed is:

1. A method comprising:
supporting a session on at least one serving gateway (SGW), where the SGW is configured to route and forward user data packets to provide communication with other network devices;
initiating at least one of a bearer and session change at the SGW by operations and management functions of the SGW;
sending a bearer request message from the SGW to a mobility management entity (MME); and
receiving a bearer response message from the MME at the SGW and completing the at least one of a bearer and session change at the SGW in accordance with the change initiated at the SGW.

2. The method of claim 1, wherein the bearer request message is an update bearer request message that initiates a session relocation from the SGW to a second SGW.

3. The method of claim 1, wherein the bearer request message is an update bearer request message that initiates an inter SGW pool relocation.

4. The method of claim 1, wherein the at least one of a bearer and session change includes a session disconnect, a session relocation, a bearer delete, a bearer disconnect, a bearer add, and a bearer modify action, each of which is indicated using a vendor specific extension.

5. The method of claim 1, wherein the SGW prompts the MME to modify the evolved radio access bearer (E-RAB) in accordance with the change initiated by the operations and management functions of the SGW.

6. The method of claim 1, further comprising:
sending a request message from the SGW to a packet data network gateway (PGW) to continue executing at least one of a bearer and session change initiated at the SGW; and
receiving a response message from the PGW at the SGW.

7. The method of claim 1, further comprising exchanging information between the SGW and at least one of the MME, a second SGW, and a serving GPRS support node (SGSN) using an echo message that includes the information.

8. The method of claim 7, wherein the information is at least one of load information, gateway health information, error logs, billing information, session information, policy information, gateway selection information, and quality of service information.

9. An apparatus comprising:
a communication means for sending and receiving data packets to and from at least one network device on a packet-based network and for sending bearer request messages to a mobility management entity (MME);
a gateway means for routing and forwarding user data packets and supporting at least one session to provide communication with other network devices; and
a means for providing operations and management functions including initiating at least one of a bearer and session change at the gateway means, wherein the gateway means communicates with at least one of the MME and a serving GPRS support node (SGSN) to continue executing at least one of a bearer and session change initiated at the gateway means.

10. The system of claim 9, wherein the bearer request message is an update bearer request message that initiates a session relocation from the gateway means to a second gateway means.

11. The system of claim 9, wherein the at least one of a bearer and session change includes a session disconnect, a session relocation, a bearer delete, a bearer disconnect, a bearer add, and a bearer modify action, each of which is indicated using a vendor specific extension.

12. A serving gateway (SGW) comprising:
an interface, configured to send and receive data packets to and from at least one network device on a packet-based network to support at least one session on the SGW, and configured to send bearer request messages from the SGW to a mobility management entity (MME); and
a processing unit, in communication with a storage medium to provide operations and management functions on the serving gateway including initiating at least one of a bearer and session change at the SGW, wherein the SGW communicates with at least one of the MME and a serving GPRS support node (SGSN) to continue executing at least one of a bearer and session change initiated at the SGW.

13. The SGW of claim 12, further comprising a command line interface to the SGW for inputting instructions including discontinuing acceptance of new calls or sessions and removing the SGW from service.

14. The SGW of claim 12, wherein the SGW is configured to report information in response to an echo request.

15. The SGW of claim 14, wherein the information is at least one of load information, gateway health information, error logs, billing information, session information, policy information, gateway selection information, and quality of service information.

16. The SGW of claim 12, wherein the bearer request message is an update bearer request message that the SGW sends to initiate a session relocation from the SGW to a second SGW.

17. The SGW of claim 12, wherein the bearer request message is an update bearer request message that the SGW sends to initiate an inter SGW pool relocation.

18. The SGW of claim 12, wherein the at least one of a bearer and session change includes a session disconnect, a session relocation, a bearer delete, a bearer disconnect, a bearer add, and a bearer modify action, each of which is indicated using a vendor specific extension.

19. The SGW of claim 12, wherein the SGW prompts the MME to modify the evolved radio access bearer (E-RAB) in accordance with the change initiated by the operations and management functions of the SGW.

20. The SGW of claim 12, wherein the SGW sends a request message from the SGW to a packet data network gateway (PGW) to continue executing at least one of a bearer and session change initiated at the SGW and receives at the interface a response message from the PGW.
